(19) United States
(12) Patent Application Publication
(10) Pub. No.: US 2010/0236861 A1
(43) Pub. Date: Sep. 23, 2010

(54) DIAPHRAGM OF ELECTRO-ACOUSTIC TRANSDUCER

(75) Inventors: Hong-Ching Her, Taichung City (TW); Ching-Lan Lin, Taichung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: MERRY ELECTRONICS CO., LTD., Taichung (TW)

(21) Appl. No.: 12/405,745

(22) Filed: Mar. 17, 2009

(51) Int. Cl. H04R 7/02

(52) U.S. Cl. 181/164; 181/167

(57) ABSTRACT

A diaphragm of an electro-acoustic transducer is provided. The diaphragm of the electro-acoustic transducer includes a central portion and a peripheral portion. The rigidity of the central portion is greater than the peripheral portion, such that the diaphragm has different rigidity characteristics, and thus gets better high-frequency performance and better sensitivity.

### BACKGROUND OF THE INVENTION

1. Field of Invention

The present invention relates to a diaphragm of an electro-acoustic transducer, in particular, to a diaphragm of an electro-acoustic transducer with two different mechanical properties obtained through heat treatment.

2. Related Art

With the rapid advancement of science and technology, demands of consumers become more diversified. For electro-acoustic products, the miniaturized design is used to meet the demands of the consumers. However, the speaker is an indispensable element of the electro-acoustic product. In order to facilitate the miniaturization of the electro-acoustic product, the speaker tends to be thin, small, and has a high tone quality. Therefore, during the miniaturization, the acoustical performance of each element of the speaker is also one of the key research items in the industry.

FIG. 1 is a schematic exploded view of a structure of a diaphragm 1 of a conventional speaker. Referring to FIG. 1, a diaphragm 1 is formed by heat-press molding a plastic material. The diaphragm 1 includes a central portion 2 and a peripheral portion 3. A pattern 4 is usually carved on the peripheral portion 3 of the diaphragm 1 to increase the softness of the peripheral portion 3, so as to enable the diaphragm 1 to obtain a better low frequency characteristic. In addition, as the diaphragm 1 generally requires a certain high frequency characteristic, a reinforcing material 5 of the metal foil is adhered to the central portion 2 to increase the strength of the central portion 2 of the diaphragm 1, so as to enable the diaphragm 1 to obtain a better high frequency characteristic, thereby compromising the high-frequency and low-frequency sound characteristics.

However, such a structure is not desirable. As the reinforcing material 5 is adhered

to the diaphragm 1 to increase the rigidity of the central portion 2 so as to achieve the desired mechanical property, the total weight of the diaphragm 1 is increased, resulting in a reduction in sensitivity and a poor electro-acoustic performance. Meanwhile, the poor adhesion effect in fabrication may cause a reduction in yield. Moreover, the cost is increased by the reinforcing material 5 added to the structure. Thus, the structure is not suitable for use in the industry.

In addition, another composite diaphragm of the conventional speaker is available on the market. A metal film or an oxide film is formed on the diaphragm by using a sputtering method, so as to increase the electro-acoustic characteristics of the speaker. However, the sputtering process is complex, the fabrication cost is high, and the coating thickness is thin, so the effect of improving the mechanical properties of the diaphragm is not distinct.

Therefore, how to enable the diaphragm of the speaker to have both the high-frequency and low-frequency sound characteristics and maintain a better sensitivity is an urgent problem to be overcome for the electro-acoustic products.

### SUMMARY OF THE INVENTION

Accordingly, an objective of the present invention is to provide a diaphragm of an electro-acoustic transducer with two different mechanical properties obtained through heat treatment.

As embodied and broadly described herein, the present invention discloses a diaphragm of an electro-acoustic transducer. The diaphragm includes a central portion and a peripheral portion. The central portion has a first crystallinity. The peripheral portion is disposed on a periphery of the central portion and has a second crystallinity. The first crystallinity of the central portion is higher than the second crystallinity of the peripheral portion. Therefore, the diaphragm has better electro-acoustic characteristics.

In comparison with the prior art, the diaphragm of the present invention has two different mechanical properties in one material by two times of heat treatment, to cause the rigidity of the central portion of the diaphragm to be greater than the peripheral portion of the diaphragm. Thus, the electro-acoustic transducer of the present invention gets a better electro-acoustic performance and better electro-acoustic characteristics.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description given herein below for illustration only, and thus are not limitative of the present invention, and wherein:

FIG. 1 is a schematic exploded view of a structure of a diaphragm of a conventional speaker;

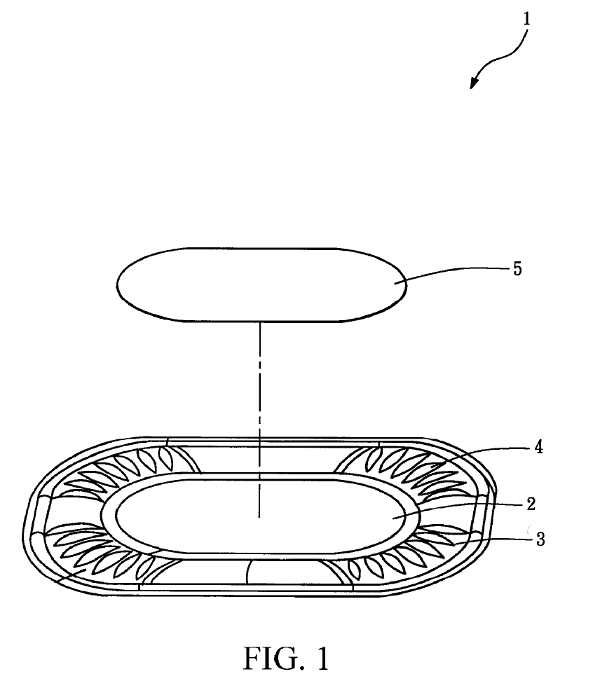

FIG. 2 is a top view of a preferred embodiment of the present invention;

FIG. 3 is a flow chart of a process for manufacturing a diaphragm of the present invention; and

FIG. 4 is a flow chart of a process for manufacturing a diaphragm according to another preferred embodiment of the present invention.

### DETAILED DESCRIPTION OF THE INVENTION

The diaphragm of the electro-acoustic transducer of the present invention is described below through embodiments with reference to the accompanying drawings.

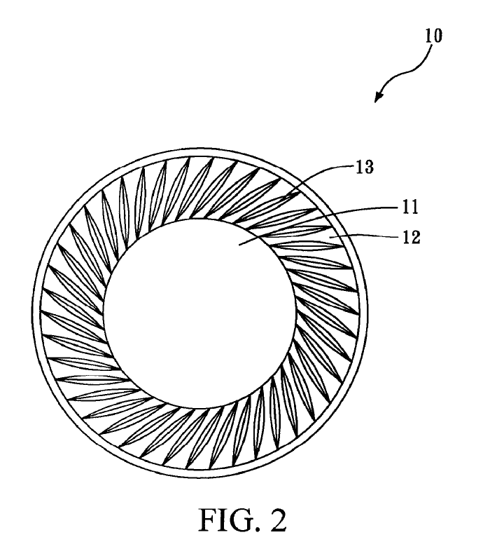

FIG. 2 is a top view of a preferred embodiment of the present invention. Referring to FIG. 2, a diaphragm 10 includes a central portion 11 and a peripheral portion 12. A pattern 13 is pressed on the peripheral portion 12 to increase the softness, so as to enable the diaphragm 10 to have a better low-frequency effect. The peripheral portion 12 is connected to a periphery of the central portion 11 which has a same thickness and a same geometric shape as the peripheral portion 12. The diaphragm 10 is a crystalline thermoplastic plastic material, and may be made of a material selected from a group consisting of polyethylene (PE), polypropylene (PP), polyamide (PA), polyacetal (POM), polybutylene terephthalate (PBT), polyethylene terephthalate (PET), polyphenylene sulfide (PPS), liquid crystal polymer (LCP), polyimide (PI), polytetrafluoroethylene (PTFE), and polyetheretherketone (PEEK).

The central portion 11 of the diaphragm 10 is subjected to heat treatment with a low cooling rate such that the central portion 11 has a first crystallinity, and the peripheral portion 12 is subjected to heat treatment with a high cooling rate such that the peripheral portion 12 has a second crystallinity. The first crystallinity is higher than the second crystallinity, and the second crystallinity may be zero. In this manner, according to the characteristics of the crystalline thermoplastic plastic, the higher the crystallinity is, the stronger the interaction of intermolecular attractive forces, thus having the rigidity characteristics. Therefore, the mechanical property of the central portion 11 of the diaphragm 10 is better than the peripheral portion 12, such that the rigidity and the Young's modulus of the central portion 11 of the diaphragm 10 are higher than the peripheral portion 12, thus enabling the diaphragm 10 to get a better high-frequency characteristic. Meanwhile, as the entire diaphragm 10 has the same thickness, the diaphragm 10 can also have a better sensitivity.

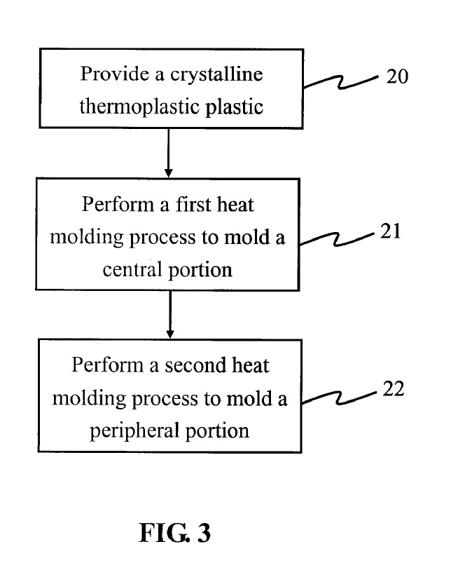

FIG. 3 is a flow chart of a process for manufacturing a diaphragm of the present invention. Referring to FIG. 3, a method for manufacturing a diaphragm of the present invention is implemented according to Steps 20 to 22 below in sequence.

In Step 20, a crystalline thermoplastic plastic material is provided (for the selection of the material, please refer to the above description).

In Step 21, a first heat molding process is performed on the crystalline thermoplastic plastic material. A processing temperature of the first heat molding process is between a glass transition point (Tg) and a melting point (Tm) of the material. The glass transition point (Tg) is preferably between −150° C. and 450° C., and the melting point (Tm) is preferably between 100° C. and 500° C. After the heating temperature increases to between the glass transition point (Tg) and the melting point (Tm), a slow cooling process is performed, so as to give the diaphragm 10 sufficient temperature and time for crystallization, thus molding the central portion 11 of the diaphragm 10 having the first crystallinity. The first heat molding process may be a compression molding, a vacuum forming, or any other similar heat treatment process.

In Step 22, a second heat molding process is performed on the crystalline thermoplastic plastic material. A processing temperature of the second heat molding process is smaller than that of the first heat molding process. After the heating temperature increases to a molding temperature of the material, a quick cooling process is performed, such that the diaphragm 10 has a low crystallization rate or cannot crystallize, thus molding the peripheral portion 12 and the pattern 13 of the diaphragm 10 having the second crystallinity, and completing the manufacturing of the diaphragm 10. The second heat molding process may be a compression molding, a vacuum forming, or any other similar heat treatment process.

Through the above manufacturing steps, the first crystallinity of the central portion 11 of the diaphragm 10 is higher than the second crystallinity of the peripheral portion 12 and the pattern 13. In this manner, the mechanical property, the rigidity, and the Young's modulus of the central portion 11 of the diaphragm 10 are better than the peripheral portion 12, thus enabling the diaphragm 10 to get a better high-frequency characteristic and a better sensitivity.

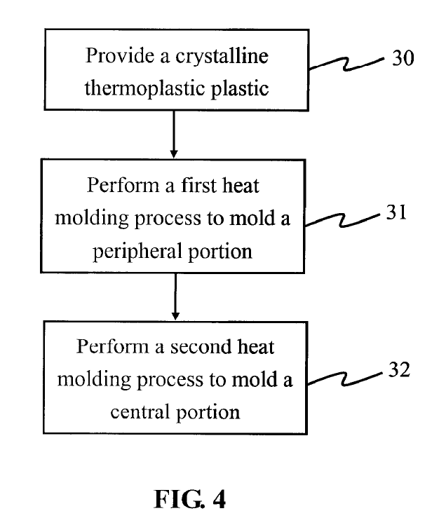

FIG. 4 is a flow chart of a process for manufacturing a diaphragm according to another preferred embodiment of the present invention. The difference of this embodiment from the above embodiment lies in that the first heat molding step and the second heat molding step of the diaphragm are inverted, and the same efficacy is achieved, as shown in Steps 30 to 32 below.

In Step 30, a crystalline thermoplastic plastic material is provided (for the selection of the material, please refer to the above description).

In Step 31, a first heat molding process is performed on the crystalline thermoplastic plastic material. After the heating temperature rises to a molding temperature of the material, a quick cooling process is performed, such that the diaphragm 10 has a low crystallization rate or cannot crystallize, thus molding the peripheral portion 12 and the pattern 13 of the diaphragm 10 having the first crystallinity. The first heat molding process may be a compression molding, a vacuum forming, or any other similar heat treatment process.

In Step 32, a second heat molding process is performed on the crystalline thermoplastic plastic material. A processing temperature of the second heat molding process is between a glass transition point (Tg) and a melting point (Tm) of the material, and is higher than that of the first heat molding process. The glass transition point (Tg) is preferably between −150° C. and 450° C., and the melting point (Tm) is preferably between 100° C. and 500° C. After the heating temperature increases to between the glass transition point (Tg) and the melting point (Tm), a slow cooling process is performed, so as to give the diaphragm 10 sufficient temperature and time for crystallization, thus molding the central portion 11 of the diaphragm 10 having the second crystallinity, and completing the manufacturing of the diaphragm 10. The second heat molding process may be a compression molding, a vacuum forming, or any other similar heat treatment process.

To sum up, for the diaphragm of the electro-acoustic transducer of the present invention, through two times of heat treatment, the structure of the diaphragm has two different mechanical properties, and thus gets a better electro-acoustic performance.

For the diaphragm of the electro-acoustic transducer of the present invention, during the molding process, the crystalline thermoplastic plastic is subjected to vacuum molding or heat-press molding with two different heating temperatures, so as to mold the central portion of the diaphragm has the high crystallinity and the peripheral portion of the diaphragm has the low or zero crystallinity. In this manner, according to the characteristics of the crystalline thermoplastic plastic, when the crystallinity is increased, the mechanical property, the rigidity, and the Young's modulus of the central portion of the diaphragm are increased, thus achieving the better high-frequency effect and reducing the distortion. Likewise, as the crystallinity of the peripheral portion of the diaphragm is smaller than the central portion, the mechanical property, the rigidity, and the Young's modulus are low, thus meeting the demand for low-frequency effect.

Furthermore, as the diaphragm of the present invention with the same material and the same thickness has different mechanical properties, the demand for the electro-acoustic characteristics of the diaphragm can be achieved without using any special process or any other reinforcing material. Thus, the high sensitivity is achieved, the distortion is reduced, and the fabrication cost is reduced, which meets the demand in the industry and gets a substantially improved efficacy.

The above descriptions are merely exemplary, and should not be construed as limitations. Any equivalent modification or variation made without departing from the spirit and scope of the present invention is included in the following claims.

What is claimed is:

1. A diaphragm of an electro-acoustic transducer, comprising:
a central portion, having a first crystallinity; and
a peripheral portion, made of a same material as the central portion, disposed on a periphery of the central portion, and having a second crystallinity smaller than the first crystallinity;
wherein the central portion and the peripheral portion of the diaphragm are respectively formed through heat treatment with different cooling rates, such that the diaphragm has two different mechanical properties.

2. The diaphragm of an electro-acoustic transducer of claim 1, wherein a thickness of the central portion is the same as that of the peripheral portion.

3. The diaphragm of an electro-acoustic transducer of claim 1, wherein a geometric shape of the central portion is the same as that of the peripheral portion.

4. The diaphragm of an electro-acoustic transducer of claim 1, wherein the second crystallinity is zero.

5. The diaphragm of an electro-acoustic transducer of claim 1, wherein the diaphragm is made of a material selected from a group consisting of polyethylene (PE), polypropylene (PP), polyamide (PA), polyacetal (POM), polybutylene terephthalate (PBT), polyethylene terephthalate (PET), polyphenylene sulfide (PPS), liquid crystal polymer (LCP), polyimide (PI), polytetrafluoroethylene (PTFE), and polyetheretherketone (PEEK).

6. The diaphragm of an electro-acoustic transducer of claim 1, wherein a process of the diaphragm comprises:
(a) performing a first heat molding process on the diaphragm to crystallize the central portion of the diaphragm; and
(b) performing a second heat molding process on the diaphragm to mold the peripheral portion of the diaphragm.

7. The diaphragm of an electro-acoustic transducer of claim 6, wherein a processing temperature of the first heat molding process is higher than the second heat molding process.

8. The diaphragm of an electro-acoustic transducer of claim 6, wherein a crystallization rate of the first crystallinity is different from that of the second crystallinity.

9. The diaphragm of an electro-acoustic transducer of claim 8, wherein the cooling rate of the first crystallinity is slow than the second crystallinity.

10. The diaphragm of an electro-acoustic transducer of claim 6, wherein a heating temperature of Step (a) is a crystallization temperature of the central portion.

11. The diaphragm of an electro-acoustic transducer of claim 10, wherein the crystallization temperature is between a glass transition point (Tg) and a melting point (Tm).

12. The diaphragm of an electro-acoustic transducer of claim 11, wherein the glass transition point (Tg) is between −150° C. and 450° C.

13. The diaphragm of an electro-acoustic transducer of claim 11, wherein the melting point (Tm) is between 100° C. and 500° C.

14. The diaphragm of an electro-acoustic transducer of claim 6, wherein a heating temperature of Step (b) is a molding temperature of the peripheral portion.

15. The diaphragm of an electro-acoustic transducer of claim 6, wherein the first heat molding process of Step (a) and the second heat molding process of the Step (b) adopt a compression molding.

16. The diaphragm of an electro-acoustic transducer of claim 6, wherein the first heat molding process of Step (a) and the second heat molding process of the Step (b) adopt a vacuum forming.
